(19) United States
(12) Patent Application Publication
(10) Pub. No.: US 2023/0401871 A1
(43) Pub. Date: Dec. 14, 2023

(54) INFORMATION PROCESSING SYSTEM, INFORMATION PROCESSING DEVICE, AND RECORDING MEDIUM

(71) Applicant: TOYOTA JIDOSHA KABUSHIKI KAISHA, Toyota-shi Aichi-ken (JP)

(72) Inventors: Masaki Ito, Toyota-shi Aichi-ken (JP); Yuki Takahashi, Sunto-gun Shizuoka-ken (JP); Koji Ide, Gotemba-shi Shizuoka-ken (JP); Hiroshi Oyagi, Kyoto-fu Kyoto-shi (JP); Yoshihisa Shinoda, Sunto-gun Shizuoka-ken (JP); Shigeki Nakayama, Gotenba-shi Shizuoka-ken (JP); Tomohiro Kaneko, Mashima-shi Shizuoka-ken (JP)

(73) Assignee: TOYOTA JIDOSHA KABUSHIKI KAISHA, Toyota-shi Aichi-ken (JP)

(21) Appl. No.: 18/203,994

(22) Filed: May 31, 2023

(30) Foreign Application Priority Data
Jun. 10, 2022 (JP) 2022-094616

(51) Int. Cl. G06V 20/56; G06V 20/52; G06V 20/40

(52) U.S. Cl. CPC G06V 20/56; G06V 20/52; G06V 20/44

(57) ABSTRACT

An information processing system includes: a vehicle that captures an image of a periphery by an in-vehicle camera; and an information processing device including a processor. Further, the processor stores acquired image data without performing privacy processing in a case where a predetermined specific event is occurred therein, and stores the acquired image data after performing the privacy processing in a case where the specific event is not occurred therein.

### CROSS-REFERENCE TO RELATED APPLICATION(S)

The present application claims priority to and incorporates by reference the entire contents of Japanese Patent Application No. 2022-094616 filed in Japan on Jun. 10, 2022.

### BACKGROUND

The present disclosure relates to an information processing system, an information processing device, and a recording medium.

Japanese Lai-open Patent Publication No. 2021-77996 discloses a technology of detecting a portion including privacy data from collected image data and concealing the portion.

### SUMMARY

There is a demand for providing an information processing system, an information processing device, and a recording medium storing an information processing program capable of performing privacy processing only when necessary instead of uniformly performing the privacy processing on all collected image data.

According to an embodiment, an information processing system includes: a vehicle that captures an image of a periphery by an in-vehicle camera; and an information processing device including a processor. Further, the processor stores acquired image data without performing privacy processing in a case where a predetermined specific event is occurred therein, and stores the acquired image data after performing the privacy processing in a case where the specific event is not occurred therein.

According to an embodiment, an information processing device includes: a processor. Further, the processor stores acquired image data without performing privacy processing in a case where a predetermined specific event is occurred therein, and stores the acquired image data after performing the privacy processing in a case where the specific event is not occurred therein.

According to an embodiment, a non-transitory computer-readable recording medium storing an information processing program causing a processor to execute: storing acquired image data without performing privacy processing in a case where a predetermined specific event is occurred therein, and storing the acquired image data after performing the privacy processing in a case where the specific event is not occurred therein.

### BRIEF DESCRIPTION OF THE DRAWINGS

FIG. 1 is a view illustrating a schematic configuration of an information processing system according to an embodiment;

FIG. 2 is a block diagram illustrating a schematic configuration of an information processing device according to the embodiment; and

FIG. 3 is a flowchart illustrating an example of a processing procedure of an information processing method (privacy processing method) executed by the information processing device according to the embodiment.

### DETAILED DESCRIPTION

In related art, it is desired to apply a technology of detecting a portion including privacy data from collected image data and concealing the portion when a person or a vehicle is identified from image data by utilization of machine learning. However, it is a demand for a technology capable of performing privacy processing only when necessary instead of uniformly performing the privacy processing on all collected image data.

An information processing system, an information processing device, and an information processing program stored in a recording medium according to an embodiment of the present disclosure will be described with reference to the drawings. Note that components in the following embodiment include what can be easily replaced by those skilled in the art or what is substantially the same.

Information Processing System

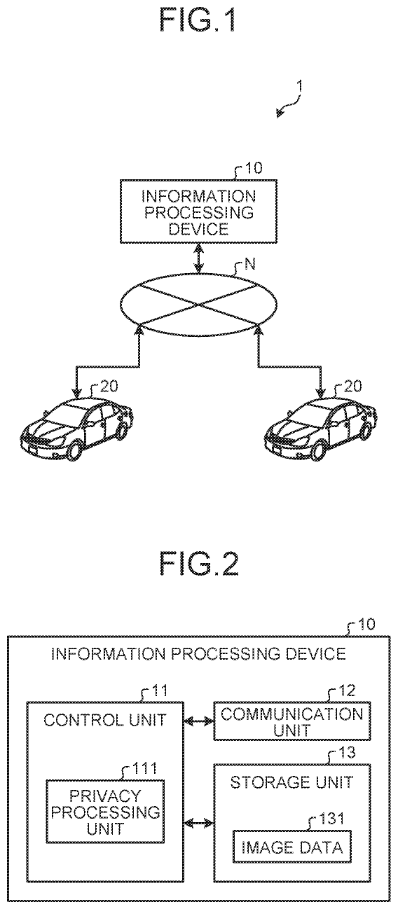

An information processing system according to the embodiment will be described with reference to FIG. 1 and FIG. 2. As illustrated in FIG. 1, an information processing system 1 includes an information processing device 10 and a vehicle 20. Both of the information processing device 10 and the vehicle 20 have communication functions and are configured to be able to communicate with each other through a network N. This network N includes, for example, an Internet network, a mobile phone network, and the like.

Information Processing Device

The information processing device 10 performs privacy processing on image data, which is acquired from the vehicle 20, under a predetermined condition. This information processing device 10 is realized by a general-purpose computer such as a workstation or a personal computer.

Here, the “privacy processing” in the present embodiment indicates processing of processing privacy data (such as data capable of specifying privacy, such as a face of a pedestrian, a vehicle number, a place name, and a shop name) included in image data later by mask processing (such as mosaic processing or the like), for example. In this privacy processing, irreversible processing is performed in such a manner that the mask cannot be removed after the processing.

As illustrated in FIG. 2, the information processing device 10 includes a control unit 11, a communication unit 12, and a storage unit 13. More specifically, the control unit 11 includes a processor including a central processing unit (CPU), a digital signal processor (DSP), a field-programmable gate array (FPGA), a graphics processing unit (GPU), and the like, and a memory (main storage unit) including a random access memory (RAM), a read only memory (ROM), and the like.

The control unit 11 realizes a function that meets a predetermined purpose by loading and executing a program, which is stored in the storage unit 13, in a work area of the main storage unit and controlling each configuration unit and the like through the execution of the program. The control unit 11 functions as a privacy processing unit 111 through the execution of the program stored in the storage unit 13.

In a case where a predetermined specific event is occurred in the image data acquired from the vehicle 20, the privacy processing unit 111 stores the image data in the storage unit 13 without performing the privacy processing. On the other hand, in a case where the predetermined specific event is not occurred in the image data acquired from the vehicle 20, the privacy processing unit 111 stores the image data in the storage unit 13 after performing the privacy processing. Note that in a case where the privacy processing is performed on the image data, the privacy processing unit 111 deletes the image data before processing (raw data) after a certain period (such as one week or the like), and does not accumulate the raw data in the storage unit 13.

Here, the “specific event” indicates, for example, an event related to a traffic accident or an incident related to a crime (hereinafter, referred to as an “accident/incident”). The term “a specific event is occurred in image data” indicates that the specific event is included in the image data and, for example, indicates that a scene of an accident/incident (such as an emergency vehicle like a police car, a fire engine, or an ambulance, an accident site, or the like) is included in the image data.

For example, after acquiring the image data from the vehicle 20, the privacy processing unit 111 determines whether the specific event is associated with the acquired image data. Then, in a case where the specific event is associated with the image data, the privacy processing unit 111 stores the image data in the storage unit 13 without performing the privacy processing thereon. On the other hand, in a case where the specific event is not associated with the image data, the privacy processing unit 111 stores the image data in the storage unit 13 after performing the privacy processing thereon. As described above, the privacy processing unit 111 does not perform the privacy processing on the image data associated with the specific event, and stores the image data in the storage unit 13 in a state in which the privacy data can be checked later. Note that the privacy processing unit 111 determines presence or absence of the specific event on the basis of, for example, an external trigger or an internal trigger.

Examples of the “external trigger” include acquiring information related to an accident/incident from the outside (such as an external server or the like that collects information related to an accident/incident). In this case, the privacy processing unit 111 determines presence or absence of the specific event on the basis of the information that is related to the accident/incident and that is acquired from the outside.

That is, the privacy processing unit 111 acquires the information related to the accident/incident from the external server or the like. Subsequently, the privacy processing unit 111 specifies image data associated with the specific event from the image data acquired from the vehicle 20 by using information related to a position (place) where the specific event is occurred or time when the specific event is occurred. Then, the privacy processing unit 111 stores the image data associated with the specific event in the storage unit 13 without performing the privacy processing. In such a manner, presence or absence of the specific event in the image data can be determined by collation of the image data on the basis of the position or time at which the specific event is occurred.

Examples of the “internal trigger” include specifying information related to an accident/incident from the image data acquired from the vehicle 20. In this case, the privacy processing unit 111 determines presence or absence of the specific event by performing image processing on the image data acquired from the vehicle 20.

That is, the privacy processing unit 111 analyzes the image data acquired from the vehicle 20 by using an image processing technology, and determines whether a scene of an accident/incident, that is, the specific event is included in the image data. Then, the privacy processing unit 111 stores an image including the specific event, that is, the image data associated with the specific event in the storage unit 13 without performing the privacy processing. In such a manner, it is possible to determine the presence or absence of the specific event in the image data by analyzing the image data itself.

The communication unit 12 includes, for example, a communication module or the like capable of transmitting and receiving various kinds of information. Through the network N, the communication unit 12 communicates with the vehicle 20, the external server, and the like, and transmits and receives various kinds of information. Note that examples of the external server include a server that collects and distributes information related to a traffic accident or an incident related to a crime.

The storage unit 13 is realized, for example, by a recording medium such as an erasable programmable ROM (EPROM), a hard disk drive (HDD), or a removable medium. Examples of the removable medium include a universal serial bus (USB) memory, and disc recording media such as a compact disc (CD), a digital versatile disc (DVD), and a Blu-ray (registered trademark) disc (BD).

The storage unit 13 can store an operating system (OS), various programs, various tables, various databases, and the like. The storage unit 13 also stores image data 131. Note that a processing result in the control unit 11, or the like may be stored in the storage unit 13 as necessary in addition to the image data 131.

The image data 131 includes, for example, image data (raw data) acquired from the vehicle 20, image data on which the privacy processing is performed by the privacy processing unit 111 (associated with a specific event), image data on which the privacy processing is not performed by the privacy processing unit 111 (not associated with the specific event), and the like.

Vehicle

The vehicle 20 is to collect image data. Examples of the vehicle 20 include a general gasoline vehicle, a hybrid electric vehicle (HEV), a plug-in hybrid electric vehicle (PHEV), a fuel cell electric vehicle (FCEV), a battery electric vehicle (BEV), and the like. In addition, the vehicle 20 may be a manually-driven vehicle or an automatically-driven vehicle.

Furthermore, the vehicle 20 includes, for example, an in-vehicle camera, and a communication function such as a data communication module (DCM). The vehicle 20 captures an image of a periphery by the in-vehicle camera, and transmits the captured image data to the information processing device 10 via the network N.

Information Processing Method

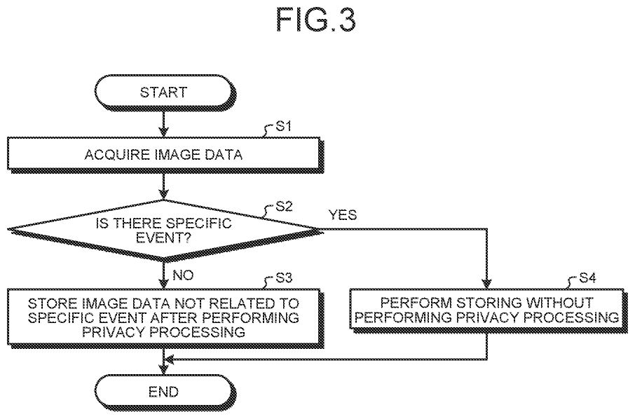

An example of a processing procedure of an information processing method (privacy processing method) executed by the information processing device according to the embodiment will be described with reference to FIG. 3.

First, the privacy processing unit 111 acquires image data from the vehicle 20 (Step S1). Subsequently, the privacy processing unit 111 determines presence or absence of a specific event with respect to each piece of the image data on the basis of, for example, the external trigger or internal trigger described above (Step S2).

In a case of determining that there is no specific event (No in Step S2), the privacy processing unit 111 performs the privacy processing on image data related to the specific event, performs storing thereof in the storage unit 13 (Step S3), and completes the present processing. On the other hand, in a case of determining that there is a specific event (Yes in Step S2), the privacy processing unit 111 stores the image data in the storage unit 13 without performing the privacy processing (Step S4), and completes the present processing.

In the information processing system, the information processing device, and the information processing program according to the embodiment described above, the privacy processing is not performed on the image data collected by the vehicle 20 in a case where the predetermined specific event is occurred, and the privacy processing is performed thereon in a case where the specific event is not occurred. As a result, since the privacy processing is not performed with respect to the image data including the specific event (such as an event related to an accident/incident), such image data can be used for an analysis of the specific event (such as an analysis of a cause of the accident/incident) or the like.

Further effects and modification examples can be easily derived by those skilled in the art. Accordingly, broader aspects of the present disclosure are not limited by the specific details and representative embodiments that are illustrated and described in the above manner. Thus, various modifications can be made without departing from the sprit or scope of a general concept of the disclosure defined by the accompanying claims and an equivalent thereof.

For example, although the vehicle 20 has been described as an example of a subject that collects image data in the present embodiment, the image data may be collected by a moving body other than the vehicle 20, another terminal device, or the like. Furthermore, although an example in which the image data is directly transferred from the vehicle 20 to the information processing device 10 has been described in the present embodiment, the image data may be temporarily accumulated in a predetermined device from the vehicle 20, and the image data may be transferred from this device to the information processing device 10.

Furthermore, although a case where image data on which the privacy processing is not performed is also stored in the storage unit 13 of the information processing device 10 has been described as an example in the present embodiment, image data on which the privacy processing is not performed may be stored in a storage unit included in a vehicle 20.

Furthermore, although an example in which the privacy processing unit 111 of the information processing device 10 performs the privacy processing on the image data has been described in the present embodiment, the information processing device 10 may only determine necessity of the privacy processing, and the privacy processing on the image data may be performed on a side of the vehicle 20. Alternatively, all of determination whether the privacy processing is necessary and the privacy processing of the image data may be performed on the side of the vehicle 20.

According to the present disclosure, the privacy processing is not uniformly performed on all the collected image data, but the privacy processing can be performed only when necessary.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing system comprising:
a vehicle that captures an image of a periphery by an in-vehicle camera; and
an information processing device including a processor, wherein
the processor is configured to store acquired image data without performing privacy processing in a case where a predetermined specific event is occurred therein, and store the acquired image data after performing the privacy processing in a case where the specific event is not occurred therein.

2. The information processing system according to claim 1, wherein
the specific event is an event related to a traffic accident or an incident related to a crime.

3. The information processing system according to claim 1, wherein
the processor is configured to
specify image data associated with the specific event by using information related to a position where the specific event is occurred or time when the specific event is occurred, and
store the specified image data without performing the privacy processing.

4. The information processing system according to claim 1, wherein
the processor is configured to determine presence or absence of the specific event on a basis of information that is related to a traffic accident or an incident related to a crime and that is acquired from outside.

5. The information processing system according to claim 1, wherein
the processor is configured to perform image processing on the acquired image data so as to determine presence or absence of the specific event.

6. An information processing device comprising:
a processor, wherein
the processor is configured to store acquired image data without performing privacy processing in a case where a predetermined specific event is occurred therein, and store the acquired image data after performing the privacy processing in a case where the specific event is not occurred therein.

7. The information processing device according to claim 6, wherein
the specific event is an event related to a traffic accident or an incident related to a crime.

8. The information processing device according to claim 6, wherein
the processor is configured to
specify image data associated with the specific event by using information related to a position where the specific event is occurred or time when the specific event is occurred, and
store the specified image data without performing the privacy processing.

9. The information processing device according to claim 6, wherein
the processor is configured to determine presence or absence of the specific event on a basis of information that is related to a traffic accident or an incident related to a crime and that is acquired from outside.

10. The information processing device according to claim 6, wherein
the processor is configured to perform image processing on the acquired image data so as to determine presence or absence of the specific event.

11. A non-transitory computer-readable recording medium storing an information processing program causing a processor to execute:
storing acquired image data without performing privacy processing in a case where a predetermined specific event is occurred therein, and storing the acquired image data after performing the privacy processing in a case where the specific event is not occurred therein.

12. The non-transitory computer-readable recording medium storing the information processing program according to claim 11, wherein the specific event is an event related to a traffic accident, or an incident related to a crime.

13. The non-transitory computer-readable recording medium storing the information processing program according to claim 11, wherein
the information processing program specifies image data associated with the specific event by using information related to a position where the specific event is occurred or time when the specific event is occurred; and
storing the specified image data without performing the privacy processing.

14. The non-transitory computer-readable recording medium storing the information processing program according to claim 11, wherein the information processing program causes the processor to execute:
determining presence or absence of the specific event on a basis of information that is related to a traffic accident or an incident related to a crime and that is acquired from outside.

15. The non-transitory computer-readable recording medium storing the information processing program according to claim 11, wherein the information processing program causes the processor to execute:
performing image processing on the acquired image data and determining presence or absence of the specific event.
